(19) United States
(12) Patent Application Publication
(10) Pub. No.: US 2019/0291276 A1
(43) Pub. Date: Sep. 26, 2019

(54) MEASUREMENT SYSTEM AND METHOD OF AN INDUSTRIAL ROBOT

(71) Applicant: UNIBAP AB, Uppsala (SE)

(72) Inventor: Lars ASPLUND, Västerås (SE)

(73) Assignee: UNIBAP AB, Uppsala (SE)

(21) Appl. No.: 16/461,551

(22) PCT Filed: Nov. 17, 2017
(86) PCT No.: PCT/SE2017/051144

§ 371 Date: May 16, 2019

(30) Foreign Application Priority Data
Nov. 22, 2016 (SE) 1630273-9

(51) Int. Cl. B25J 9/16; B25J 19/02

(52) U.S. Cl. CPC B25J 9/1692; B25J 19/023

(57) ABSTRACT

A measuring system of an industrial robot comprises a plurality of moveable arms including a tool holder and a 3D camera carried by the industrial robot. The measuring system further comprises a mirror for creating a mirror object of a real object. The 3D camera is fixed to one of the moveable arms for measurement of the mirror object.

### CROSS-REFERENCE TO RELATED APPLICATION(S)

This application is a national stage application (filed under 35 § U.S.C. 371) of PCT/SE2017/051144, filed Nov. 17, 2017 of the same title, which, in turn, claims priority to Swedish Application No. 1630273-9 filed Nov. 22, 2016; the contents of each of which are hereby incorporated by reference.

### FIELD OF THE INVENTION

The present invention concerns an industrial robot. More precisely the invention concerns a measuring method for determining an object in the working area of the industrial robot. By the expression industrial robot should be understood a manipulator having a plurality of moveable parts and a control system. The structure of an industrial robot may in the following text be denoted manipulator or robot.

### BACKGROUND OF THE INVENTION

To operate an industrial robot in an industrial environment the robot must be calibrated in a local coordinate system. This means that the tool center point (TCP) must be exactly known in all positions of the local coordinate system. In many cases the local robot coordinate system must be calibrated to comply with a global coordinate system where a work piece may be located.

A great many calibration methods are known. Often the robot moves a calibration tool to different positions where it is sensed by a sensing unit in a global coordinate system. Such sensing unit may for instance comprise a touch sensing unit, crossing laser beams or camera units. It is also known the use of a touchscreen for calibration purposes.

From WO2015165062 a method for calibration of a tool center point of an industrial robot is previously known. The method involves a cross beam sensor having a first laser beam and a second laser beam. From WO2012076038 a method for calibrating a robot unit is previously known. The object is to provide a method for calibrating a first coordinate system of a root unit with a second coordinate system of an object identification unit. The method comprises generating a plurality of target points to which a calibration tool is to be moved by the robot unit for calibration. The target points are evaluated by use of a camera unit.

### SUMMARY OF THE INVENTION

A primary object of the present invention is to seek ways to improve a measurement system and method of an industrial robot.

According to the invention the industrial robot carries a 3D camera and uses a mirror for creating a mirror object of a real object to determine the position of the real object. Prior to the measurement the 3D camera is fixed on the robot structure. The position and orientation of the 3D camera is thus known in a local coordinate system. In an embodiment the local coordinate system is the same as the coordinate system of the industrial robot. The mirror is also defined in the local coordinate system and thus measurement on the mirror object may be used to define the real object.

A 3D camera comprises means for producing a three dimensional image of a real object. Commonly a 3D camera comprises a stereo camera containing two optical lines each with a lens and an image sensor. With such a stereo camera any object in the robot working area may be determined in space. The stereo camera not only determines an object in a plane but also determines the distance to the object. However a stereo camera fixed to the robot structure has blind sectors where an object cannot be seen. According to the invention, the introduction of a mirror into the working area these blind sectors are eliminated by the use of a mirror image. In an embodiment the 3D camera comprises processor means and memory means to execute instructions from a computer program. By using a mirror the robot may reflect itself to find out parts that cannot be seen by the camera from its fixed position. This is of great help when localizing an object picked up by the robot or to define a new TCP for example of a worn or damaged tool, such as a drill. The robot is controlled to hold the object in front of the mirror. The stereo camera defines the plane of the mirror by measuring at least three position marks on the mirror. Thus the plane of the mirror is now defined in the local coordinate system. Having defined the mirror position and orientation, the 3D camera calculates by using triangulation the position of the tool tip from the mirror object. By performing measurements of a plurality of points on the object also the orientation of the object may be determined.

According to the invention the position and orientation of any object held by the robot may be investigated by the mirror technique. Thus for the picking industry a robot carrying a 3D camera can locate an object to be picked, define the position and orientation of the object in its picking tool and place the object in a predetermined position in a known container. In an embodiment the mirror comprises a screen or a wall with a known position and orientation. In an embodiment the mirror is attached to the manipulator.

In a first aspect of the invention the object is achieved by a measuring system of an industrial robot comprising a plurality of moveable arms including a tool holder and a 3D camera carried by the industrial robot, wherein the measuring system further comprises a mirror for creating a mirror object of a real object, and that the 3D camera is fixed to one of the moveable arms for measurement of the mirror object.

In an embodiment the mirror comprises at least three position marks to define its plane. In an embodiment the 3D camera comprises means for calculation of the position of the real object by triangulation calculation of the mirror object. In further embodiments the 3D camera is fixed to the innermost part of the second arm, the industrial robot comprises six moveable arms, and the real object comprises the tool center point (TCP) of the industrial robot.

In a second aspect of the invention the object is achieved by a method for measurement of a real object held by an industrial robot comprising a plurality of moveable arms including a tool holder and a 3D camera carried by the industrial robot, by providing a mirror in the working area of the robot, fixing the 3D camera to one of the moveable arms, moving the industrial robot to create a mirror object of the real object, and calculating the space position of the real object from triangulation of the mirror object. In an embodiment the method further comprises measuring the plane of the mirror from at least three position marks on the mirror. In an embodiment the method is carried out by execution of a computer program.

### BRIEF DESCRIPTION OF THE DRAWINGS

Other features and advantages of the present invention will become more apparent to a person skilled in the art from the following detailed description in conjunction with the appended drawings in which:

FIG. 1 is a three dimensional view of an industrial robot in front of a mirror according the invention, and

FIG. 2 is a principal view of a 3D camera and the triangulation method used according to the invention.

### DETAILED DESCRIPTION OF THE INVENTION

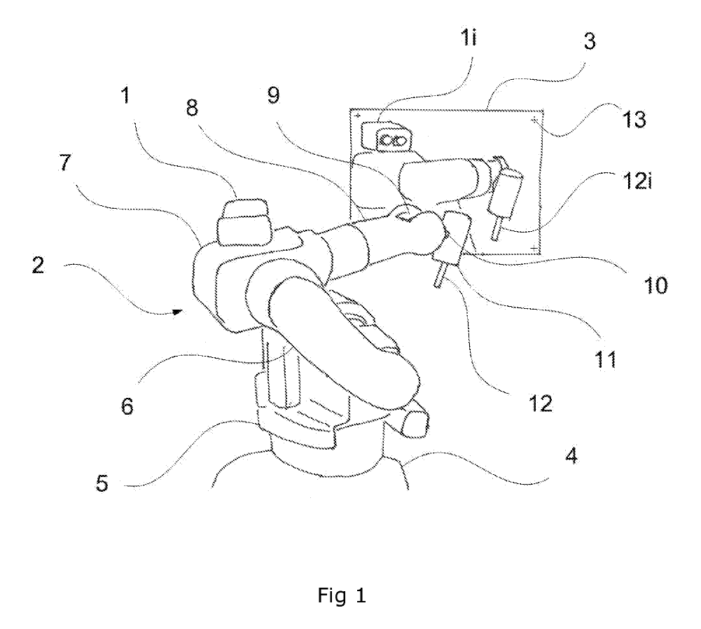

A system for measuring an object held by the robot according to the invention is shown in FIG. 1. A 3D camera 1 is fixed on a manipulator 2 of an industrial robot and a mirror 3 is positioned in the working area of the manipulator. In the embodiment shown in the figure the manipulator comprises a foot 4 carrying a rotatable arranged stand 5. The stand carries a pivotally arranged first arm 6 which carries a pivotally arranged second arm 7. At its outer end the second arm carries a rotatable wrist part 8 and a pivotable hand part 9 which carries a rotatable tool holder 10. In the embodiment shown the tool holder carries a drill apparatus 11 with a drill 12.

In the embodiment shown the mirror 3 is located in the working area of the manipulator 2 such that the drill 12 is seen by the 3D camera 1. The mirror comprises a plane structure having at least three position marks 13. The camera cannot see the drill from its position on the structure of the manipulator. The manipulator is moving the drill in front of the mirror such that the drill may be detected by the 3D camera. In this position the distance and orientation of the mirror is determined by measuring the three position marks on the mirror. Having incorporated the mirror into the local coordinate system the position of the drill is measured and calculated by the 3D camera.

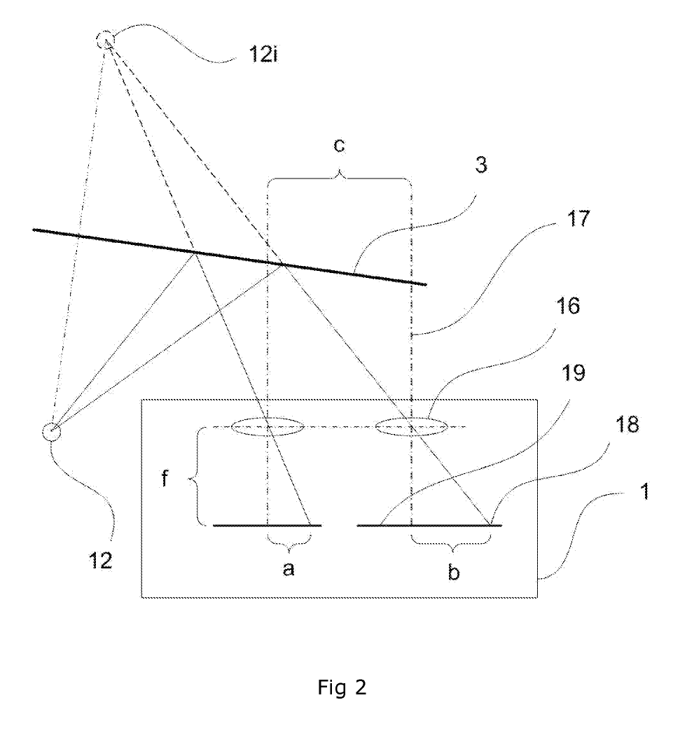

The method of calculating the position of an object 14 by use of a mirror 3 is shown in FIG. 2. In the embodiment shown the position and orientation of the mirror is previously determined by measuring three position marks on the mirror plane. Thus by use of a mirror a mirror object 12i of the real object 12 is seen by the 3D camera 1. The 3D camera comprises two lenses 16 each having a center line 17 between which there is a known distance c. An object is projected through the two lenses 16 and detected as an image 18 on an image sensor 19. In the camera the focal distance f between the lens and the image sensor is known. For sake of clarity only the righthand part of the camera has been given figure designations.

An optical line from the mirror object 12i is projected through each of the lenses onto each image sensor 19. In the lefthand part of the camera the projection of the mirror object 12i is detected at a distance a from the centerline 17. In the righthand part of the camera the projection of the mirror image 12i is detected at a distance b from the centerline 17. Thus from triangulation the distance and location of the object may be calculated by calculating means in the camera.

The mirror may have any size but must be plane. The mirror may be fixed in the working area of the robot but may also be put in place when needed. Each time the piece of machinery carried by the manipulator must be determined the position and orientation of the mirror must first be determined. Thereafter the position of an object or the tip of the tool may be investigated. By measurement of a plurality of points on the object also the orientation of the object may be determined. In case of a mirror having a big surface such as a whole or a part of a wall the determination of the mirror position and orientation may be used for multiple measurements.

Although the manipulator shown in the embodiment comprises six axes a manipulator according to the invention may just comprise a plurality of axes. Thus the invention may be used on any manipulator having for instance only two axes or two degrees of freedom. Many manipulators used for drilling or picking may have only a few degrees of freedom. In such cases the 3D camera may be fixed to any of the moveable parts. Considering the size of the camera it should be fixed to the second or third outermost part of the robot in order not to interfere with the tool itself.

By fixing the 3D camera to the robot structure all object visualized by the camera may be determined in the local coordinate system of the robot. Thus there is no need to orient the robot or its working object in a global coordinate system surrounding the local coordinate system. By help of the mirror the robot may visualize parts of a working object not being seen by the camera. Likewise the camera may by the mirror determine objects like a tool which is located in a blind sector of the camera. In an embodiment of the invention the mirror technique may be used for calibration of an industrial robot.

Although favorable the scope of the invention must not be limited by the embodiments presented but contain also embodiments obvious to a person skilled in the art. For instance a single 2D camera may be used in two positions. However such determination of an object in space is more time consuming and less accurate than the use of a 3D camera. Besides, the object must not be moved from its position between the two camera positions. According to the invention a plurality of mirrors may be used.

1. A measuring system of an industrial robot comprising a plurality of moveable arms including a tool holder and a 3D camera carried by the industrial robot, said measuring system further comprises:
a mirror for creating a mirror object of a real object, and
wherein the 3D camera is fixed to one of the moveable arms for measurement of the mirror object.

2. A measuring system according to claim 1, wherein the mirror comprises at least three position marks defining a plane of the mirror.

3. A measuring system according to claim 1, wherein the 3D camera comprises means for calculation of a position of the real object by triangulation calculation of the position of the mirror object.

4. A measuring system according to claim 1, wherein the 3D camera is fixed to an innermost part of the second arm.

5. A measuring system according to claim 1, wherein the industrial robot comprises six moveable arms.

6. A measuring system according claim 1, wherein the real object comprises a tool center point (TCP) of the industrial robot.

7. A method for measurement of a real object held by an industrial robot wherein said industrial robot comprises a plurality of moveable arms, a tool holder, a mirror in the working area of the robot, and a 3D camera fixed to one of the moveable arms, and wherein the method comprises:
moving the industrial robot to create a mirror object of the real object, and
calculating by triangulation of the position of the mirror object the position of the real object.

8. A method according to claim 7, further comprising:
measuring a plane defined by the mirror from at least three position marks on the mirror.

9. A computer program product storable on a non-transitory computer readable medium, said computer program product for measurement of a real object held by an industrial robot wherein said industrial robot comprises a plurality of moveable arms, a tool holder, a mirror in the working area of the robot, and a 3D camera fixed to one of the moveable arms, said computer program product comprising computer instructions to cause one or more processors to perform the following operations:
moving the industrial robot to create a mirror object of the real object; and
calculating by triangulation of the position of the mirror object the position of the real object.

10. (canceled)

11. (canceled)

12. A computer program product according to claim 9, further comprising computer instructions to cause one or more processors to perform the operation of:
measuring a plane defined by the mirror from at least three position marks on the mirror.
